(19) United States
(12) Patent Application Publication
(10) Pub. No.: US 2026/0292268 A1
(43) Pub. Date: Sep. 24, 2026

(54) CODING ORDER CONTROL METHOD FOR LOSSLESS POINT CLOUD COMPRESSION

(71) Applicant: InterDigital VC Holdings, Inc., Wilmington, DE (US)

(72) Inventors: Jiahao Pang, Plainsboro, NJ (US); Muhammad Asad Lodhi, Highland Park, NJ (US); Junghyun Ahn, New York, NY (US); Dong Tian, Boxborough, MA (US)

(21) Appl. No.: 19/083,252

(22) Filed: Mar. 18, 2025

(51) Int. Cl. H04N 19/96; H04N 19/169; H04N 19/597; H04N 19/91

(52) U.S. Cl. CPC H04N 19/96; H04N 19/169; H04N 19/597; H04N 19/91

(57) ABSTRACT

Some embodiments of a method may include: obtaining already-decoded attributes of a current level; predicting probability distributions of attributes not decoded in the current level, wherein the predicting is based on the already-decoded attributes of the current level and previous levels; determining attributes to be decoded at a current iteration; obtaining probability distributions of the attributes to be decoded at the current iteration; obtaining a bitstream of the attributes to be decoded at the current iteration; and decoding, from the bitstream, with arithmetic decoding, the attributes to be decoded at the current iteration, wherein decoding the attributes is based on the probability distributions of the attributes to be decoded at the current iteration.

### INCORPORATION BY REFERENCE

The present application incorporates by reference in their entirety the following applications: U.S. Non-Provisional patent application Ser. No. 18/830,379, entitled “VOXEL-WISE CODING CONTROL METHOD FOR LOSSLESS POINT CLOUD COMPRESSION” and filed Sep. 10, 2024 (“379 application”); U.S. Non-Provisional patent application Ser. No. 18/829,989, entitled “END-TO-END LEARNING-BASED DYNAMIC POINT CLOUD ATTRIBUTE CODING FRAMEWORK” and filed Sep. 10, 2024 (“989 application”); U.S. Non-Provisional patent application Ser. No. 18/814,402, entitled “END-TO-END LEARNING-BASED POINT CLOUD ATTRIBUTE CODING FRAMEWORK” and filed Aug. 23, 2024 (“402 application”); U.S. Non-Provisional patent application Ser. No. 18/814,400, entitled “LEARNING-BASED POINT CLOUD GEOMETRY COMPRESSION FRAMEWORK” and filed Aug. 23, 2024 (“400 application”); and U.S. Non-Provisional patent application Ser. No. 18/784,466, entitled “END-TO-END LEARNING-BASED DYNAMIC POINT CLOUD CODING FRAMEWORK” and filed Jul. 25, 2024 (“466 application”).

### BACKGROUND

The present application is related to point cloud compression.

### SUMMARY

A first example method in accordance with some embodiments may include: obtaining already-decoded attributes of a current level; predicting probability distributions of attributes not decoded in the current level, wherein the predicting is based on the already-decoded attributes of the current level and previous levels; determining attributes to be decoded at a current iteration; obtaining probability distributions of the attributes to be decoded at the current iteration; obtaining a bitstream of the attributes to be decoded at the current iteration; and decoding, from the bitstream, with arithmetic decoding, the attributes to be decoded at the current iteration, wherein decoding the attributes is based on the probability distributions of the attributes to be decoded at the current iteration.

For some embodiments of the first example method, wherein determining attributes to be decoded at the current iteration includes performing attribute selection to select the attributes to be decoded at the current iteration, and wherein performing attribute selection is based on the probability distributions of the attributes to be decoded at the current iteration.

Some embodiments of the first example method may further include performing attribute deserialization using the attributes selected to be decoded.

For some embodiments of the first example method, performing attribute deserialization includes outputting a feedback loop of the attributes to be decoded at the current iteration.

For some embodiments of the first example method, attribute selection includes: concatenating the attributes remaining to be encoded; performing feature aggregation on the concatenated attributes remaining to be decoded, wherein the feature aggregation generates a score for each of the attributes remaining to be decoded; and sorting the scores into an order for decoding the attributes, wherein decoding the attributes is further based on the order for decoding the attributes.

For some embodiments of the first example method, attribute selection includes: generating a confidence level for each of the attributes remaining to be decoded; and sorting the confidence levels into an order for decoding the attributes, wherein decoding the attributes is further based on the order for decoding the attributes.

For some embodiments of the first example method, the attributes include voxel occupancies.

For some embodiments of the first example method, wherein determining attributes to be decoded at the current iteration includes performing voxel selection to select voxel occupancies to be decoded at the current iteration, and wherein performing voxel selection is based on the probability distributions of the attributes to be decoded at the current iteration.

Some embodiments of the first example method may further include performing voxel deserialization using the voxel occupancies selected to be decoded.

A first example apparatus in accordance with some embodiments may include: a processor; and a memory storing instructions operative, when executed by the processor, to cause the apparatus to: obtain already-decoded attributes of a current level; predict probability distributions of attributes not decoded in the current level, wherein the predicting is based on the already-decoded attributes of the current level and previous levels; determine attributes to be decoded at a current iteration; obtain probability distributions of the attributes to be decoded at the current iteration; obtain a bitstream of the attributes to be decoded at the current iteration; and decode, from the bitstream, with arithmetic decoding, the attributes to be decoded at the current iteration, wherein decoding the attributes is based on the probability distributions of the attributes to be decoded at the current iteration.

A second example method in accordance with some embodiments may include: obtaining already-encoded attributes of a current level; predicting probability distributions of attributes not encoded in the current level, wherein the predicting is based on the already-encoded attributes of the current level and previous levels; determining attributes to be encoded at a current iteration; obtaining probability distributions of the attributes to be encoded at the current iteration; and encoding, into a bitstream, with arithmetic encoding, the attributes to be encoded at the current iteration, wherein encoding the attributes is based on the probability distributions of the attributes to be encoded at the current iteration.

For some embodiments of the second example method, determining attributes to be encoded at the current iteration includes: performing attribute selection to select the attributes to be encoded; and performing attribute serialization using the attributes remaining to be encoded.

For some embodiments of the second example method, performing attribute selection is based on the probability distributions of the attributes to be encoded at the current iteration.

For some embodiments of the second example method, performing attribute serialization generates a vector of attributes selected to be encoded at the current iteration.

For some embodiments of the second example method, attribute selection includes: concatenating the attributes remaining to be encoded; performing feature aggregation on the concatenated attributes remaining to be encoded, wherein the feature aggregation generates a score for each of the attributes remaining to be encoded; and sorting the scores into an order for encoding the attributes, wherein encoding the attributes is further based on the order for encoding the attributes.

For some embodiments of the second example method, attribute selection includes: generating a confidence level for each of the attributes remaining to be encoded; and sorting the confidence levels into an order for encoding the attributes, wherein encoding the attributes is further based on the order for encoding the attributes.

For some embodiments of the second example method, the attributes include voxel occupancies.

For some embodiments of the second example method, determining attributes to be encoded at the current iteration includes: performing voxel selection to select voxel occupancies to be encoded; and performing voxel serialization using voxel occupancies remaining to be encoded.

For some embodiments of the second example method, performing voxel selection is based on probability distributions of the voxel occupancies to be encoded at the current iteration.

For some embodiments of the second example method, performing voxel serialization generates a vector of the voxel occupancies selected to be encoded at the current iteration.

### BRIEF DESCRIPTION OF THE DRAWINGS

The following detailed description will be better understood when read in conjunction with the appended drawings, in which there are shown examples of one or more of the multiple embodiments of the present application. It should be understood, however, that the embodiments described herein are not limited to the precise arrangements and instrumentalities shown in the drawings. In the drawings:

FIG. 1 is a system diagram illustrating an example set of interfaces for a system according to some embodiments.

FIG. 2 is a process diagram illustrating an example process for lossless point cloud coding in a tree-structure according to some embodiments.

FIG. 3 is a process diagram illustrating an example traditional coding order with all voxels coded in one step according to some embodiments.

FIG. 4 is a process diagram illustrating an example traditional process for encoding the current LoD (level of detail) with context modeling according to some embodiments.

FIG. 5 is a process diagram illustrating an example traditional process for decoding the current LoD with context modeling according to some embodiments.

FIG. 6 is a process diagram illustrating an example process for lossless point cloud coding in a tree-structure for geometry according to some embodiments.

FIG. 7 is a process diagram illustrating an example traditional coding order for geometry with all voxels coded in one step according to some embodiments.

FIG. 8 is a process diagram illustrating an example coding order with voxels coded in multiple steps according to some embodiments.

FIG. 9 is a process diagram illustrating an example coding order with voxels coded in multiple steps according to some embodiments.

FIG. 10 is a process diagram illustrating an example encoding of the current LoD in multiple steps with context modeling according to some embodiments.

FIG. 11 is a process diagram illustrating an example decoding of the current LoD in multiple steps with context modeling according to some embodiments.

FIG. 12 is a process diagram illustrating an example attribute encoding of the current LoD with an adaptive coding coder according to some embodiments.

FIG. 13 is a process diagram illustrating an example attribute decoding of the current LoD with an adaptive coding coder according to some embodiments.

FIG. 14 is a process diagram illustrating an example geometry encoding of the current LoD with an adaptive coding coder according to some embodiments.

FIG. 15 is a process diagram illustrating an example geometry decoding of the current LoD with an adaptive coding coder according to some embodiments.

FIG. 16 is a process diagram illustrating an example learning-based voxel selection process according to some embodiments.

FIG. 17 is a process diagram illustrating an example non-learning-based voxel selection process according to some embodiments.

FIG. 18 is a flowchart illustrating an example process for iteratively encoding point cloud data at an octree level according to some embodiments.

FIG. 19 is a flowchart illustrating an example process for iteratively decoding point cloud data at an octree level according to some embodiments.

The entities, connections, arrangements, and the like that are depicted in—and described in connection with—the various figures are presented by way of example and not by way of limitation. As such, any and all statements or other indications as to what a particular figure “depicts,” what a particular element or entity in a particular figure “is” or “has,” and any and all similar statements—that may in isolation and out of context be read as absolute and therefore limiting—may only properly be read as being constructively preceded by a clause such as “In at least one embodiment, . . . ” For brevity and clarity of presentation, this implied leading clause is not repeated ad nauseum in the detailed description.

### DETAILED DESCRIPTION

In describing the various embodiments of the present application, certain terminology is used herein for convenience only and should not be considered as limiting such embodiments. In the drawings, the same reference numerals are employed for designating the same elements throughout the several figures and the present description.

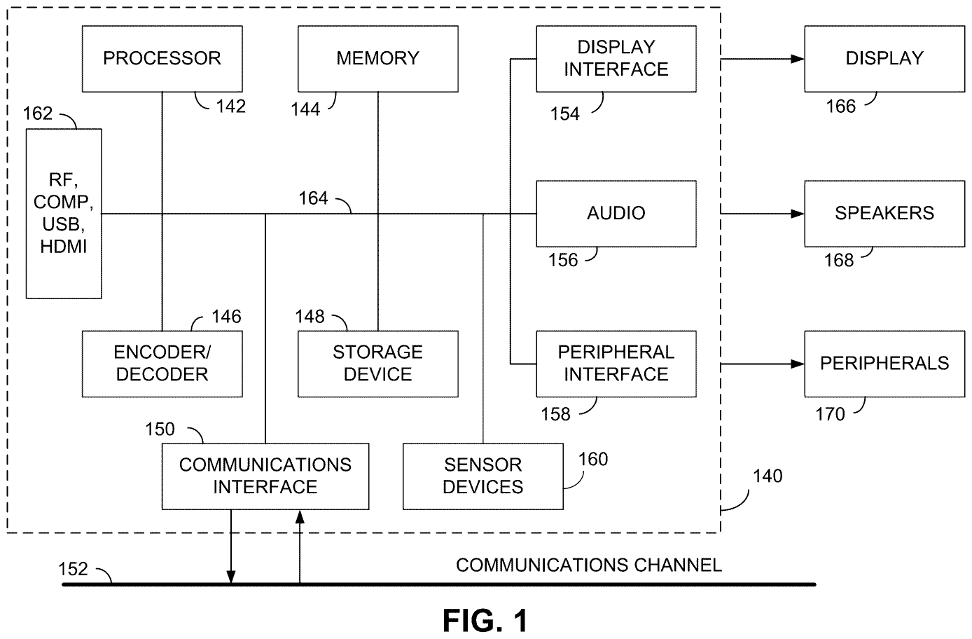

FIG. 1 is a system diagram illustrating an example set of interfaces for a system according to some embodiments. An extended reality display device, together with its control electronics, may be implemented using a system such as the system of FIG. 1. System 140 can be embodied as a device including the various components described below and is configured to perform one or more of the aspects described in this document. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 140, singly or in combination, can be embodied in a single integrated circuit (IC), multiple ICs, and/or discrete components. For example, in at least one embodiment, the processing and encoder/decoder elements of system 140 are distributed across multiple ICs and/or discrete components. In various embodiments, the system 140 is communicatively coupled to one or more other systems, or other electronic devices, via, for example, a communications bus or through dedicated input and/or output ports. In various embodiments, the system 140 is configured to implement one or more of the aspects described in this document.

The system 140 includes at least one processor 142 configured to execute instructions loaded therein for implementing, for example, the various aspects described in this document. Processor 142 may include embedded memory, input output interface, and various other circuitries as known in the art. The system 140 includes at least one memory 144 (e.g., a volatile memory device, and/or a non-volatile memory device). System 140 may include a storage device 148, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 148 can include an internal storage device, an attached storage device (including detachable and non-detachable storage devices), and/or a network accessible storage device, as non-limiting examples.

System 140 includes an encoder/decoder module 146 configured, for example, to process data to provide an encoded video or decoded video, and the encoder/decoder module 146 can include its own processor and memory. The encoder/decoder module 146 represents module(s) that can be included in a device to perform the encoding and/or decoding functions. As is known, a device can include one or both of the encoding and decoding modules. Additionally, encoder/decoder module 146 can be implemented as a separate element of system 140 or can be incorporated within processor 142 as a combination of hardware and software as known to those skilled in the art.

Program code to be loaded onto processor 142 or encoder/decoder 146 to perform the various aspects described in this document can be stored in storage device 148 and subsequently loaded onto memory 144 for execution by processor 142. In accordance with various embodiments, one or more of processor 142, memory 144, storage device 148, and encoder/decoder module 146 can store one or more of various items during the performance of the processes described in this document. Such stored items can include, but are not limited to, the input video, the decoded video or portions of the decoded video, the bitstream, matrices, variables, and intermediate or final results from the processing of equations, formulas, operations, and operational logic.

In some embodiments, memory inside of the processor 142 and/or the encoder/decoder module 146 is used to store instructions and to provide working memory for processing that is needed during encoding or decoding. In other embodiments, however, a memory external to the processing device (for example, the processing device can be either the processor 142 or the encoder/decoder module 142) is used for one or more of these functions. The external memory can be the memory 144 and/or the storage device 148, for example, a dynamic volatile memory and/or a non-volatile flash memory. In several embodiments, an external non-volatile flash memory is used to store the operating system of, for example, a television. In at least one embodiment, a fast external dynamic volatile memory such as a RAM is used as working memory for video coding and decoding operations, such as for MPEG-2 (MPEG refers to the Moving Picture Experts Group, MPEG-2 is also referred to as ISO/IEC 13818, and 13818-1 is also known as H.222, and 13818-2 is also known as H.262), HEVC (HEVC refers to High Efficiency Video Coding, also known as H.265 and MPEG-H Part 2), or VVC (Versatile Video Coding, a new standard being developed by JVET, the Joint Video Experts Team).

The input to the elements of system 140 can be provided through various input devices as indicated in block 162. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 1, include composite video.

In various embodiments, the input devices of block 162 have associated respective input processing elements as known in the art. For example, the RF portion can be associated with elements suitable for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which can be referred to as a channel in certain embodiments, (iv) demodulating the downconverted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, downconverting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF portion includes an antenna.

Additionally, the USB and/or HDMI terminals can include respective interface processors for connecting system 140 to other electronic devices across USB and/or HDMI connections. It is to be understood that various aspects of input processing, for example, Reed-Solomon error correction, can be implemented, for example, within a separate input processing IC or within processor 142 as necessary. Similarly, aspects of USB or HDMI interface processing can be implemented within separate interface ICs or within processor 142 as necessary. The demodulated, error corrected, and demultiplexed stream is provided to various processing elements, including, for example, processor 142, and encoder/decoder 146 operating in combination with the memory and storage elements to process the datastream as necessary for presentation on an output device.

Various elements of system 140 can be provided within an integrated housing, Within the integrated housing, the various elements can be interconnected and transmit data therebetween using suitable connection arrangement 164, for example, an internal bus as known in the art, including the Inter-IC (12C) bus, wiring, and printed circuit boards.

The system 140 includes communication interface 150 that enables communication with other devices via communication channel 152. The communication interface 150 can include, but is not limited to, a transceiver configured to transmit and to receive data over communication channel 152. The communication interface 150 can include, but is not limited to, a modem or network card and the communication channel 152 can be implemented, for example, within a wired and/or a wireless medium.

Data is streamed, or otherwise provided, to the system 140, in various embodiments, using a wireless network such as a Wi-Fi network, for example IEEE 802.11 (IEEE refers to the Institute of Electrical and Electronics Engineers). The Wi-Fi signal of these embodiments is received over the communications channel 152 and the communications interface 150 which are adapted for Wi-Fi communications. The communications channel 152 of these embodiments is typically connected to an access point or router that provides access to external networks including the Internet for allowing streaming applications and other over-the-top communications. Other embodiments provide streamed data to the system 140 using a set-top box that delivers the data over the HDMI connection of the input block 162. Still other embodiments provide streamed data to the system 140 using the RF connection of the input block 162. As indicated above, various embodiments provide data in a non-streaming manner. Additionally, various embodiments use wireless networks other than Wi-Fi, for example a cellular network or a Bluetooth network.

The system 140 can provide an output signal to various output devices, including a display 166, speakers 168, and other peripheral devices 170. The display 166 of various embodiments includes one or more of, for example, a touchscreen display, an organic light-emitting diode (OLED) display, a curved display, and/or a foldable display. The display 166 can be for a television, a tablet, a laptop, a cell phone (mobile phone), or other device. The display 166 can also be integrated with other components (for example, as in a smart phone), or separate (for example, an external monitor for a laptop). The other peripheral devices 170 include, in various examples of embodiments, one or more of a stand-alone digital video disc (or digital versatile disc) (DVR, for both terms), a disk player, a stereo system, and/or a lighting system. Various embodiments use one or more peripheral devices 170 that provide a function based on the output of the system 140. For example, a disk player performs the function of playing the output of the system 140.

In various embodiments, control signals are communicated between the system 140 and the display 166, speakers 168, or other peripheral devices 170 using signaling such as AV.Link, Consumer Electronics Control (CEC), or other communications protocols that enable device-to-device control with or without user intervention. The output devices can be communicatively coupled to system 140 via dedicated connections through respective interfaces 154, 156, and 158. Alternatively, the output devices can be connected to system 140 using the communications channel 152 via the communications interface 150. The display 166 and speakers 168 can be integrated in a single unit with the other components of system 140 in an electronic device such as, for example, a television. In various embodiments, the display interface 154 includes a display driver, such as, for example, a timing controller (T Con) chip.

The display 166 and speaker 168 can alternatively be separate from one or more of the other components, for example, if the RF portion of input 162 is part of a separate set-top box. In various embodiments in which the display 166 and speakers 168 are external components, the output signal can be provided via dedicated output connections, including, for example, HDMI ports, USB ports, or COMP outputs.

The system 140 may include one or more sensor devices 160. Examples of sensor devices that may be used include one or more GPS sensors, gyroscopic sensors, accelerometers, light sensors, cameras, depth cameras, microphones, and/or magnetometers. Such sensors may be used to determine information such as user's position and orientation. Where the system 140 is used as the control module for an extended reality display (such as control modules), the user's position and orientation may be used in determining how to render image data such that the user perceives the correct portion of a virtual object or virtual scene from the correct point of view. In the case of head-mounted display devices, the position and orientation of the device itself may be used to determine the position and orientation of the user for the purpose of rendering virtual content. In the case of other display devices, such as a phone, a tablet, a computer monitor, or a television, other inputs may be used to determine the position and orientation of the user for the purpose of rendering content. For example, a user may select and/or adjust a desired viewpoint and/or viewing direction with the use of a touch screen, keypad or keyboard, trackball, joystick, or other input. Where the display device has sensors such as accelerometers and/or gyroscopes, the viewpoint and orientation used for the purpose of rendering content may be selected and/or adjusted based on motion of the display device.

The embodiments can be carried out by computer software implemented by the processor 142 or by hardware, or by a combination of hardware and software. As a non-limiting example, the embodiments can be implemented by one or more integrated circuits. The memory 144 can be of any type appropriate to the technical environment and can be implemented using any appropriate data storage technology, such as optical memory devices, magnetic memory devices, semiconductor-based memory devices, fixed memory, and removable memory, as non-limiting examples. The processor 142 can be of any type appropriate to the technical environment, and can encompass one or more of microprocessors, general purpose computers, special purpose computers, and processors based on a multi-core architecture, as non-limiting examples.

A User Equipment (UE) may correspond to any extended Reality (XR) device/node which may come in variety of form factors. Typical UE (e.g., XR UE) may include, but not limited to the following: Head Mounted Displays (HMD), optical see-through glasses and video see-through HMDs for Augmented Reality (AR) and Mixed Reality (MR), mobile devices with positional tracking and camera, wearables etc. In addition to the above, several different types of XR UE may be envisioned based on XR device functions for e.g., as display, camera, sensors, sensor processing, wireless connectivity, XR/Media processing, and power supply, to be provided by one or more devices, wearables, actuators, controllers and/or accessories. One or more device/nodes/UEs may be grouped into a collaborative XR group for supporting any of XR applications/experience/services.

### Point Cloud Data Format

The field of point cloud compression and processing aims to develop tools for compression, analysis, interpolation, representation, and understanding of point cloud signals.

Point cloud data is a universal data format used across several business domains from autonomous driving, robotics, AR/VR, civil engineering, computer graphics, to the animation/movie industry. 3D LiDAR sensors have been deployed in self-driving cars, and affordable LiDAR sensors are released from Velodyne Velabit, Apple iPad Pro 2020, and Intel RealSense LiDAR camera L515. With advances in sensing technologies, 3D point cloud data becomes more practical than ever.

Point cloud data is also believed to consume a large portion of network traffic, e.g., among connected cars over 5G network, and immersive communications (VR/AR). Efficient representation formats may be necessary for point cloud understanding and communication. In particular, raw point cloud data may be organized and processed for the purposes of world modeling and sensing. Compression of raw point clouds may be used when storage and transmission of the data are used in related scenarios.

Furthermore, point clouds may represent a sequential scan of the same scene, which contains multiple moving objects. They are called dynamic point clouds, while static point clouds may be captured from a static scene or static objects. Dynamic point clouds are typically organized into frames, with different frames being captured at different times. Dynamic point clouds may require the processing and compression to be handled in real-time or with low delay.

Each point of the point clouds may be represented by at least a 3D position (x, y, z). The set of 3D positions illustrates the geometry of the object/scene from which the point cloud is captured. Additionally, each point of the point cloud may be associated with some attributes, depending on the applications. For example, for VR/AR/Gaming, the attribute includes color (r, g, b); and for LiDAR, the attribute may include reflectance.

### Point Cloud Data Use Cases

The automotive industry and autonomous cars are domains in which point clouds may be used. Autonomous cars are able to “probe” their environment to make good driving decisions based on the reality of their immediate surroundings. Typical sensors, like LiDARs, produce (dynamic) point clouds that are used by the perception engine. These point clouds are not intended to be viewed by human eyes and they are typically sparse, not necessarily colored, and dynamic with a high frequency of capture. They may have other attributes, like the reflectance ratio provided by the LiDAR because this attribute may be indicative of the material of the sensed object and this attribute may be used in making a decision.

Virtual Reality (VR) and immersive worlds have become a hot topic and are foreseen by many as the future of 2D flat video. The viewer is immersed in an environment all around the viewer, while in standard TV the viewer may look only at the virtual world in front of the viewer. There are several gradations in the immersivity depending on the freedom of the viewer in the environment. Point clouds are a good format candidate to distribute VR worlds. They may be static or dynamic and are typically of average size, with, e.g., no more than millions of points at a time.

Point clouds also may be used for various purposes, such as cultural heritage/buildings in which objects, like statues or buildings, are scanned in 3D to share the spatial configuration of the object without sending or visiting the statues or buildings. Also, point clouds offer a way to ensure preservation of knowledge of the object in case the original object, for instance, is destroyed by an earthquake. Such point clouds are typically static, colored, and huge.

Another use case is in topography and cartography in which, when using 3D representations, maps are not limited to the plane and may include the relief. Google Maps is a good example of 3D maps but is understood to use meshes instead of point clouds. Nevertheless, point clouds may be a suitable data format for 3D maps, and such point clouds are typically static, colored, and huge.

World modeling and sensing via point clouds may be a technology that allows machines to gain knowledge about the 3D world around them, which may be used by the applications discussed above.

3D point cloud data include discrete samples on the surfaces of objects or scenes. A huge number of points may be used to fully represent the real world with point samples. For instance, a typical VR immersive scene may contain millions of points, while point clouds typically contain hundreds of millions of points. Therefore, the processing of such large-scale point clouds may be computationally expensive, especially for consumer devices, such as smartphones, tablets, and automotive navigation systems, that have limited computational power.

The first step for processing or inference on a point cloud is to have efficient storage methodologies. To store and process the input point cloud with affordable computational cost, the point cloud may be down-sampled first, in which the down-sampled point cloud summarizes the geometry of the input point cloud while having much fewer points. The down-sampled point cloud may be inputted into a machine task for further processing. However, further reduction in storage space may be achieved by converting the raw point cloud data (original or down-sampled) into a bitstream through entropy coding techniques for lossless compression.

In addition to lossless coding, many scenarios may use lossy coding for significantly improved compression ratios while maintaining the induced distortion under certain quality levels. To achieve a less lossy coding, an efficient point feature extractor may be used to improve the accuracy of the reconstruction within the given resource budget.

A challenge when using a learning-based method for lossless point cloud coding is on how to effectively estimate the probability distribution and perform the encoding/decoding. To improve the probability distribution estimation process, the estimation may be broken into multiple fixed steps when coding one octree level. This application further considers the order of coding the attributes (or voxels), e.g., what content to code at each coding step. This application introduces a selection process to pick some of the attributes (or voxels) to be coded at each coding step. By optimizing this coding order, the overall coding performance may be further improved.

### Learning-Based Point Cloud Compression

For some embodiments, since point cloud data is composed of two components: geometry information and attribute information, the compression of point clouds may be classified into two categories: geometry coding and attribute coding. Learning-based technology for lossless point cloud compression may be applied to both point cloud geometry compression and attribute compression.

A challenge when using a learning-based method for lossless point cloud coding is how to effectively estimate the probability distribution and perform encoding and decoding. In traditional learning-based methods of losslessly encoding point cloud, computing of probabilities for the voxels at a current level may compute the probabilities of all voxels at once. The '379 application breaks down this probability estimation and coding process into multiple steps. For some embodiments, further gains may be attained by choosing which voxels to code in each step of this process.

### Coding All Voxels At Once

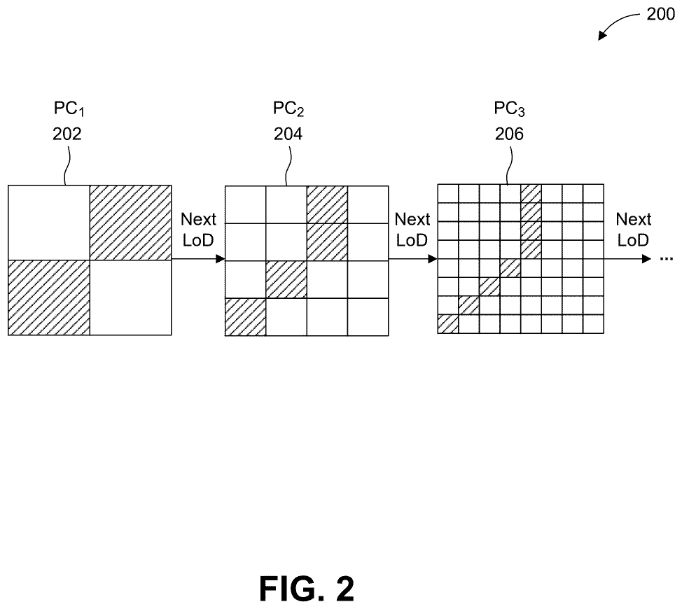

FIG. 2 is a process diagram illustrating an example process for lossless point cloud coding in a tree-structure according to some embodiments. FIG. 2 shows a traditional technique 200 for lossless voxel-based point cloud coding represented in an octree structure, with a focus on attribute coding. The case of geometry coding may be viewed as a special case of attribute coding in which the attributes are binary-either occupied (0) or empty (1).

To encode/decode a point cloud represented in an octree structure, one may traverse from the first level of detail (LoD) of the octree all the way to the last LoD of the octree. The example of FIG. 2 shows the coding of the first level (denoted as PC₁ (202), the second level (denoted as PC₂ (204)), and the third level (denoted as PC₃ (206)).

In FIG. 2 and other FIGS., 2D examples are used just for illustration. When processing a particular level, the encoding/decoding of the current LoD is performed based on all the known information-either from the previously coded voxels or from other side information. Without loss of generality, FIG. 2 shows the coding of the second level (denoted as PC₂ (204)), and attribute coding may be used as an example.

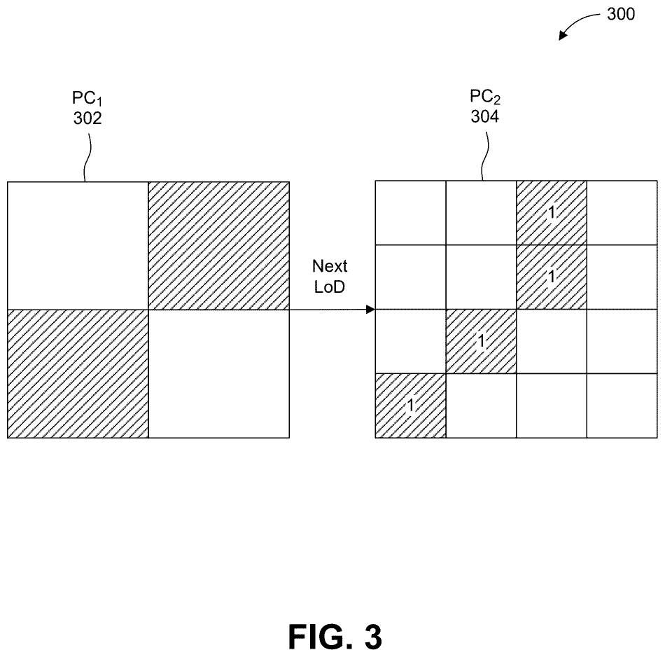

FIG. 3 is a process diagram illustrating an example traditional coding order with all voxels coded in one step according to some embodiments. To code the contents of each voxel in PC₂ (304), the traditional method 300 computes the probability distributions of the attributes for the voxels in one step simultaneously, as shown in FIG. 3. The number “1” means step one in FIG. 3. The coding of the first level is denoted as PC₁ (302).

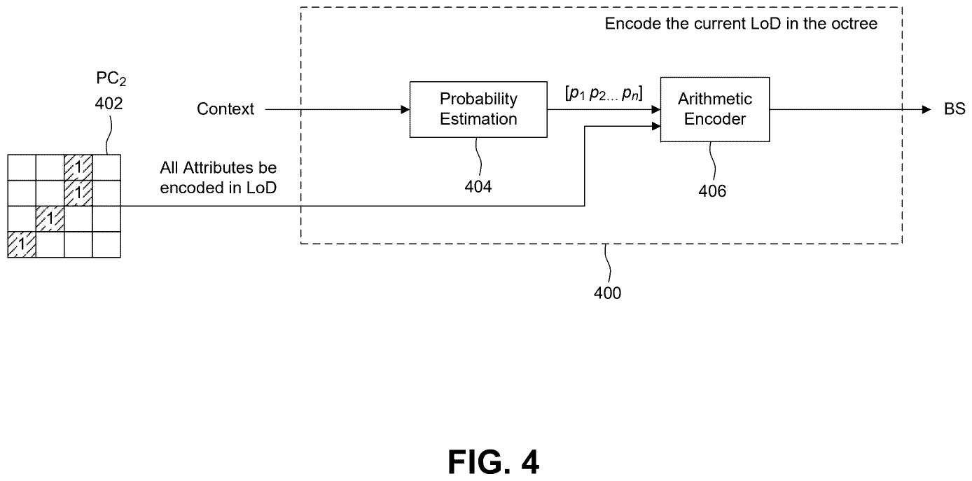

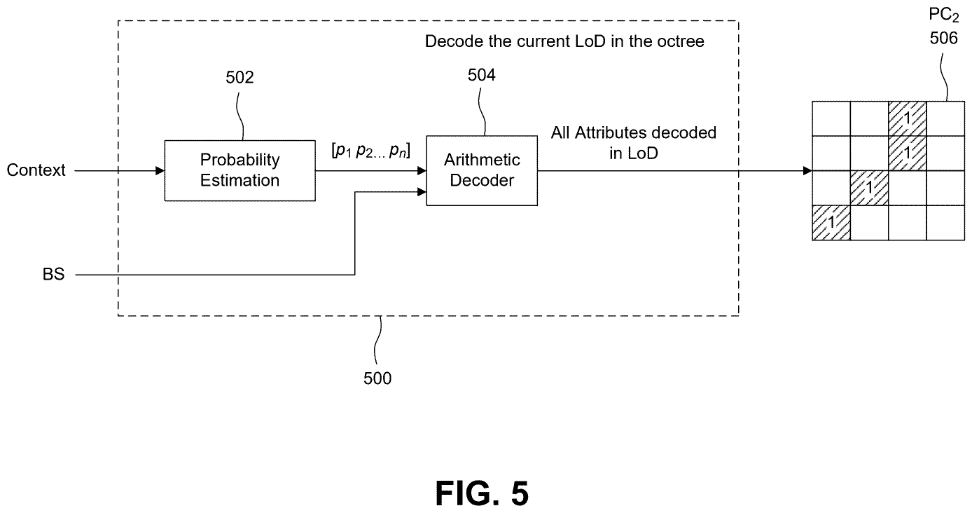

The associated encoding and decoding diagrams are provided in FIGS. 4 and 5, respectively.

FIG. 4 is a process diagram illustrating an example traditional process for encoding the current LoD with context modeling according to some embodiments. Suppose there are n attribute values in PC₂ (402) to be encoded. For the example encoder 400 of FIG. 4, given the context from the previously already encoded voxels of the previous LoD, the probability estimation block 404 computes the probability distributions of all of these n attribute values in one step, leading to the probability distributions of each of the attribute values ([p₁, p₂, . . . , pₙ]), where each of the pᵢ is a M-dimension vector that sums up to one. The probability estimation block 404 is a block based on neural networks. For color attributes ranging from 0 to 255, M is 256. For reflectance of LiDAR readings ranging from 0 to 99, M is 100. In the case of coding geometry, where the values are binary, M is 2. After that, the arithmetic coder 406 takes the n input values and encodes them losslessly with the assistance of the estimated probability distributions. The arithmetic coder 406 outputs a bitstream (BS).

FIG. 5 is a process diagram illustrating an example traditional process for decoding the current LoD with context modeling according to some embodiments. For the example decoder 500 of FIG. 5, the probability estimation block 502 takes the context information from the previously already encoded voxels of the previous LoD and again computes the probability distributions of each of the attribute values ([p₁, p₂, . . . , pₙ]). The arithmetic decoder 504 takes the input bitstream and decodes all the n attribute values in one step. This arithmetic decoding process 504 is assisted by the estimated probability distributions [p₁, p₂, . . . , pₙ]. The arithmetic decoder 504 outputs PC₂ (506).

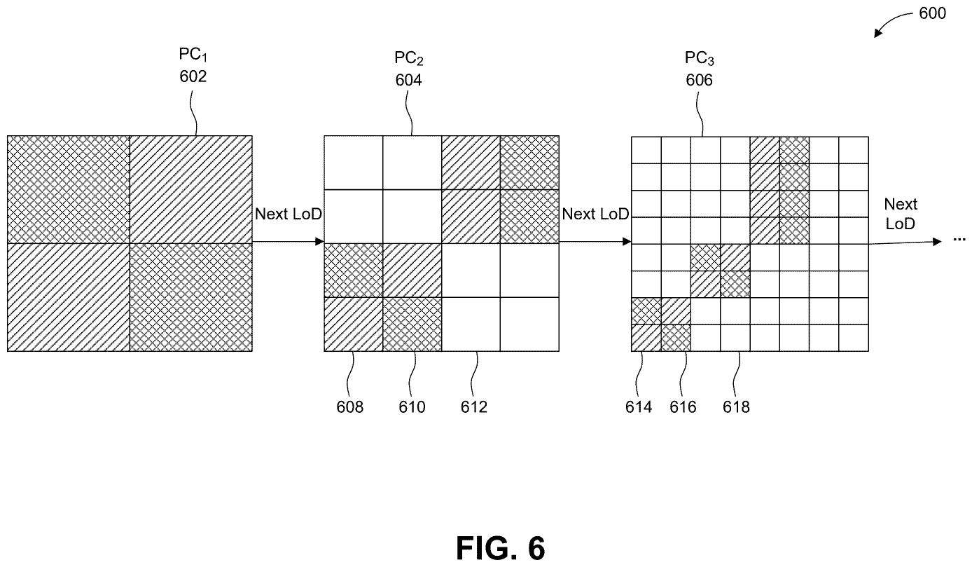

FIG. 6 is a process diagram illustrating an example process for lossless point cloud coding in a tree-structure for geometry according to some embodiments. When dealing with geometry coding, the steps are similar, as shown in the process 600 of FIG. 6. The process 600 traverses from the first LoD (and associated point cloud PC₁ (602) to the second LoD (and associated point cloud PC₂ (604) to the third (last) LoD (and associated point cloud PC₃ (606)) of the octree.

In FIG. 6, the diagonal-lined voxels 608, 614 are occupied voxels. The cross-haired voxels 610, 618 and the clear voxels 612, 618 are empty voxels. The cross-haired voxels 610, 618 are empty voxels that need to be encoded/decoded at the associated level. At each level, the occupancy values are coded for those voxels whose parents are occupied. Thus, for each LoD, the coding of the geometry is the same as the coding of attributes, except that, for geometry coding, values to be coded are binary, which indicates the occupancy status of the voxels. Thus, with the traditional design, all of the voxels of the current LoD are coded at once.

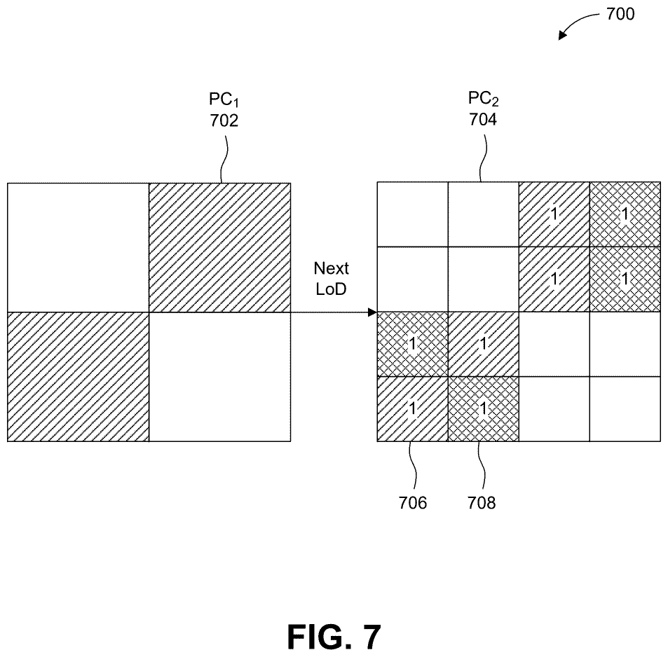

FIG. 7 is a process diagram illustrating an example traditional coding order for geometry with all voxels coded in one step according to some embodiments. See FIG. 7 for an illustrative example process 700. In FIG. 7, the number “1” means step one. The process 700 traverses from a first LoD (and associated point cloud PC₁ (702) to a second LoD (and associated point cloud PC₂ (704). The diagonal-lined voxels 706 are occupied voxels, and the cross-haired voxels 708 are empty voxels.

The core of having an effective lossless octree coder is to have better probability estimation. However, a limitation of the traditional method is that the process estimates the probability distributions of all of the voxels simultaneously. And, as understood, there is no way to use any sibling information in the current LoD to assist the probability estimation process. In other words, the inter-voxel correlations are not utilized in this design, which leads to sub-optimal performance.

### Coding Voxel-by-Voxel (2024ID00636)

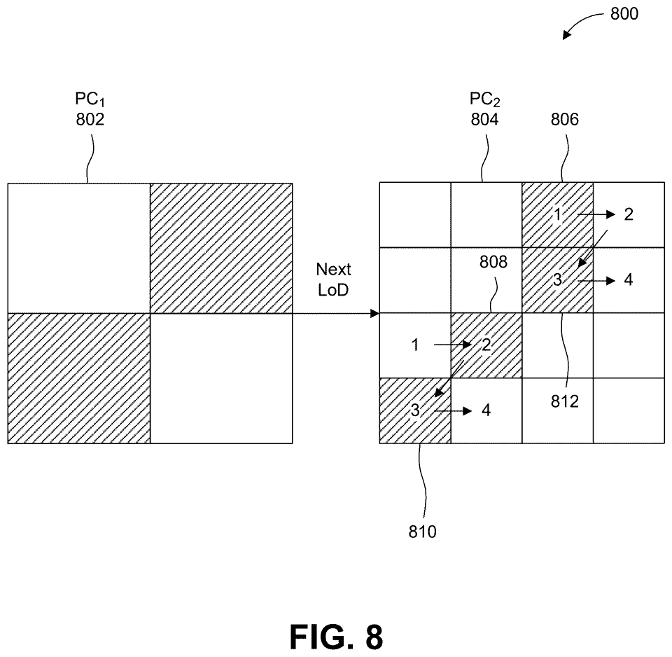

FIG. 8 is a process diagram illustrating an example coding order with voxels coded in multiple steps according to some embodiments. To code the voxels of a LoD, the '379 application takes a multi-step approach, as shown in FIG. 8. Particularly, the voxels are classified into several groups according to their positions relative to their parents. Thus, in 2D there will be 4 groups while in 3D there will be 8 groups.

Rather than coding all the groups at one time, the '379 application codes them with more than one step. The groups that are coded later in the process 800 may use the earlier, already-coded groups at the same LoD to estimate the probabilities. This methodology leads to more precise probability estimation and a smaller bitstream. The process 800 traverses from a first LoD (and associated point cloud PC₁ (802) to a second LoD (and associated point cloud PC₂ (804).

In the example of FIG. 8, one group is coded at a time, leading to the voxel-by-voxel coding approach. In the attribute coding example of FIG. 8, certain steps for the empty voxels may be skipped. In this particular example, the occupied voxels labeled with a “1” (806) are coded first. The process 800 proceeds to the occupied voxels labeled as “2” (808), then the occupied voxels labeled as “3” (810, 812), and finally the occupied voxels labeled as “4”. Since there is no voxel labeled as “4” is occupied, the fourth step may be skipped.

For some embodiments, the coding steps of process 800 may be described slightly differently as shown below. Firstly, the occupied voxel labeled with “1” in the upper right (the voxel with “1” highlighted with diagonal line pattern) is coded. Secondly, the occupied voxel labeled with “2” in the bottom left (the voxel with “2” highlighted with line pattern) is coded. Thirdly, the two occupied voxels labeled with “3” in the upper right and bottom left (the two voxels with “3” highlighted with line pattern) are coded. Lastly, the occupied voxels with “4” should be coded. But this fourth step may be skipped for the example process 800 shown in FIG. 8 because no voxels labeled as “4” are occupied.

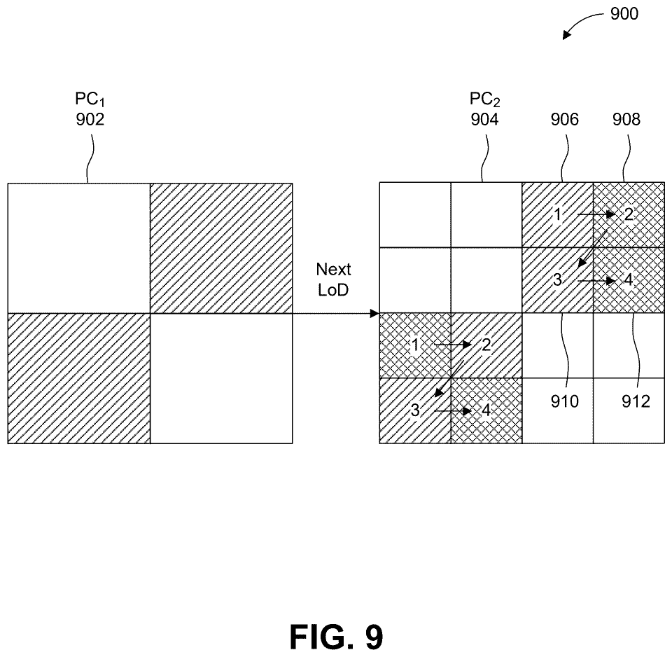

FIG. 9 is a process diagram illustrating an example coding order with voxels coded in multiple steps according to some embodiments. When coding geometry as shown in FIG. 9, the rationale is the same, the only difference is that all voxels with occupied parents need to be encoded, even if a voxel itself is empty.

The process 900 traverses from a first LoD (and associated point cloud PC₁ (902)) to a second LoD (and associated point cloud PC₂ (904). The diagonal-lined voxels 906, 910 are occupied voxels. The cross-haired voxels 908, 912 (and the clear voxels) are empty voxels. The voxels labeled with a “1” (906) are coded first. The process 900 proceeds to the voxels labeled as “2” (908), then the voxels labeled as “3” (910), and finally the voxels labeled as “4” (912).

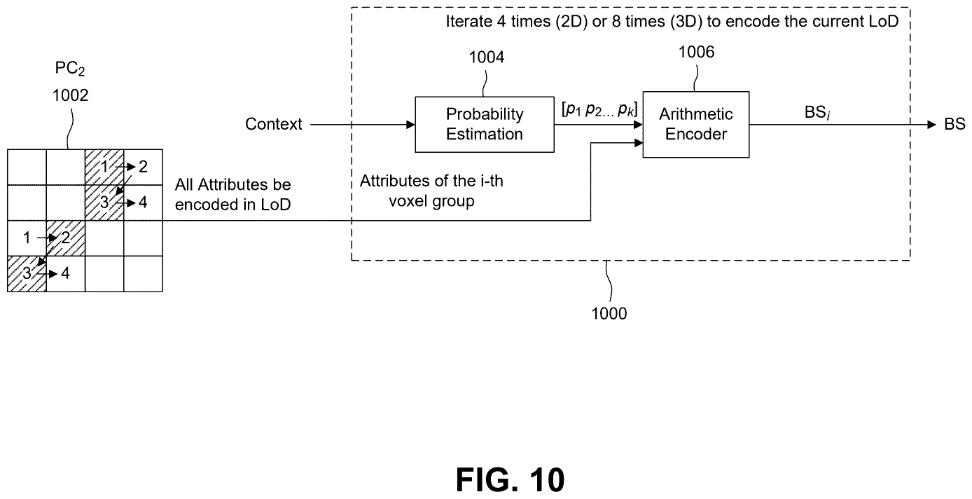

FIG. 10 is a process diagram illustrating an example encoding of the current LoD in multiple steps with context modeling according to some embodiments. The encoder design 1000 of the '379 application is provided in FIG. 10. Instead of performing one-step coding of the traditional design, the encoder 1000 iterates more than one time to complete the encoding process.

If a voxel-by-voxel approach is used, the process uses an 8-step coding process for 3D. Suppose there are k voxels in the i-th group of point cloud PC₂ (1002). In the i-th step, the goal is to encode the k voxels in the i-th group. Context information is accessed for not only the parent LoD but also the voxels in the current LoD that have already been encoded. The context information is used by the probability estimation block 1004 to estimate the probability distributions of the current group, denoted as [p₁, p₂, . . . , pk]. The arithmetic encoder 1006 performs arithmetic encoding of the voxel attributes, based on the estimated probability distributions [p₁, p₂, . . . , pk]. The sub-bitstream BSᵢ is outputted for the i-th step. By aggregating all the sub-bitstreams, the bitstream is obtained for the current LoD.

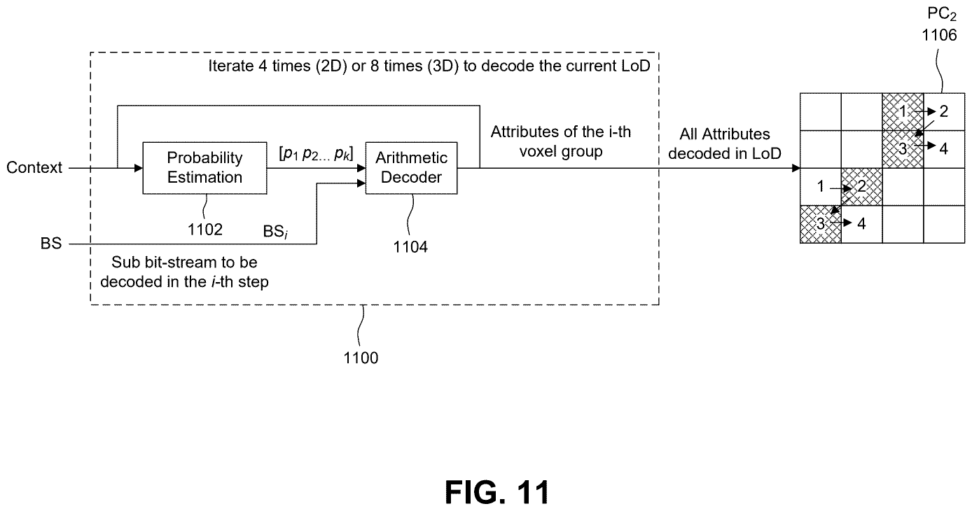

FIG. 11 is a process diagram illustrating an example decoding of the current LoD in multiple steps with context modeling according to some embodiments. The decoder design of the '379 application follows the same rationale as its corresponding encoder and iteratively decodes the voxel groups. The decoder design 1100 is provided in FIG. 11. Instead of performing the traditional design of one-step coding, the decoder 1100 iterates more than one time to accomplish the decoding process.

Some embodiments that decode voxel-by-voxel, 8 steps are used to accomplish the entire decoding process for 3D. In the i-th step, the goal is to decode the i-th group of voxels. Context information is accessed for not only the parent LoD but also the already-decoded voxels in the current LoD. The context information is used by the probability estimation block 1102 to estimate the probability distributions of the current voxel group to be decoded. In this way, the same probability distributions [p₁, p₂, . . . , pk] that were used on the encoder side are reproduced on the decoder side. The arithmetic encoder 1104 performs arithmetic decoding of the sub-bitstream BSᵢ for the current voxel group, based on the estimated probability distributions [p₁, p₂, . . . , pk], leading to the decoded attributes of the i-th voxel group. By aggregating the decoded attributes of all voxel groups, all of the attributes for the current LoD are obtained for a point cloud PC₂ (1108).

The encoding and decoding of geometry follow the same rationale. Instead of encoding all 8 voxels simultaneously, the coding process is split into several steps. The way the voxel groups are partitioned at the decoder needs to be exactly the same as the associated encoder. In other words, such partitioning should be known by the decoder in order to decode a bitstream. In some embodiments, the voxel group partitioning information may be sent to the decoder as a syntax element in the high-level syntax.

Coding the voxel groups one-by-one helps to reduce the overall bitstream size. However, the coding order in the '379 application (FIG. 9) is always fixed. For example, in attribute coding, some voxels may correspond to high-frequency contents (e.g., edges, patterns) while some of the voxels correspond to low-frequency contents (e.g., in some homogeneous flat region). In this case, coding the high-frequence content first may be more beneficial, so as to lay a solid foundation for the coding of the low-frequency content. In this case, a fixed coding order may be sub-optimal.

### Attribute Coding

To encode a current LoD in an octree, the coding process is decomposed into multiple steps, as shown in the '379 application. Additionally, before the coding of each step, an evaluation is done of which voxel (or voxels) should be coded in the coming step. Thus, the coding order is adaptively determined according to the input content. The encoder and decoder designs are described below using attribute coding as an example.

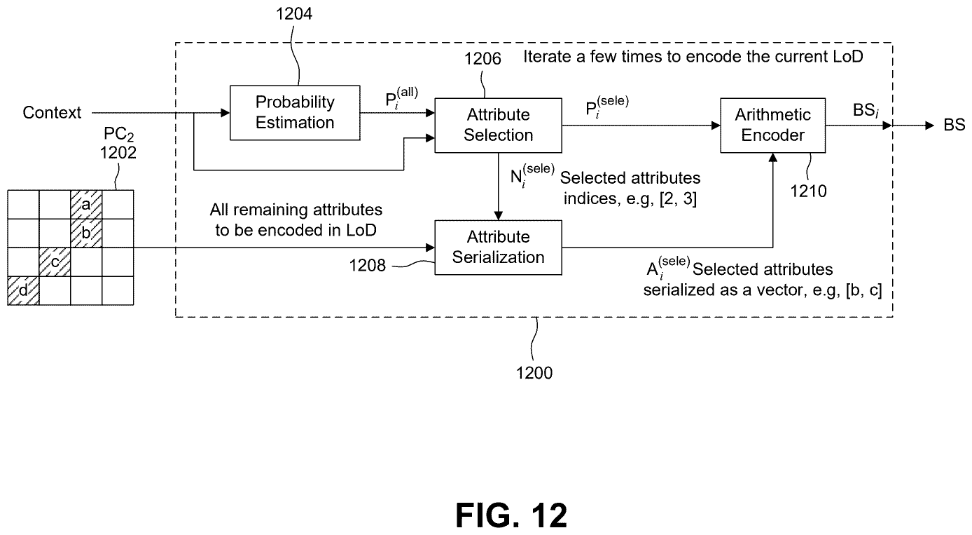

FIG. 12 is a process diagram illustrating an example attribute encoding of the current LoD with an adaptive coding coder according to some embodiments. FIG. 12 shows an example encoder 1200, which iterates a few times to encode the current LoD. Particularly, the design shows the i-th encoding iteration in which some of the voxels have already been encoded in the previous (i−1) encoding iterations.

When performing encoding at the i-th encoding iteration, two inputs are used: (1) all of the remaining attributes to be encoded for point cloud PC₂ (1202); and (2) the context information for the already-encoded attributes. The probability estimation block 1204 estimates the probability distributions of all the remaining attributes to be encoded, denoted as

$${P}_{i}^{( all )} .$$

Based on

$${P}_{i}^{( all )}$$

and the context information, the Attribute Selection block 1206 identifies a few attributes among all the attributes to be encoded in the current iteration. The Attribute Selection block 1206 outputs the indices of the selected attributes, denoted as

$${N}_{i}^{( s e l e )} .$$

Additionally, the Attribute Selection block 1206 outputs the probability distributions of the selected attributes, denoted by

$${P}_{i}^{( s e l e )} .$$

The selected probability distributions

$${P}_{i}^{( s e l e )}$$

come from the probability distributions of all the remaining attributes to be encoded

$${P}_{i}^{( all )} .$$

In other words,

$${P}_{i}^{( s e l e )} ∈ {P}_{i}^{( all )} .$$

In some embodiments, the Attribute Selection block 1206 is a neural-network-based block, which performs a binary classification of all of the remaining attributes to be coded in this LoD and classifies them as either selected or not selected.

The Attribute Serialization block 1208 takes as inputs the selected attribute indices

$${N}_{i}^{( s e l e )}$$

and all the remaining attributes to be encoded in the current LoD. From all the remaining attributes to be encoded in the current LoD, the Attribute Serialization block 1208 takes out the selected attributes to be encoded according to the selected attribute indices

$${N}_{i}^{( s e l e )} .$$

The Attribute Serialization block 1208 outputs the selected attributes, which form a vector denoted as

$${A}_{i}^{( s e l e )} .$$

The vector

$${A}_{i}^{( s e l e )}$$

contains all the attribute values to be encoded in this i-th iteration.

Given the selected attributes

$${A}_{i}^{( sel e )}$$

and the associated probability distributions

$${P}_{i}^{( s e l e )} ,$$

the arithmetic encoder 1210 encodes

$${A}_{i}^{( sele )}$$

and outputs the sub-bitstream BSᵢ. The above encoding iteration repeats until all of the attributes in the current LoD have been encoded. All of the sub-bitstream BSᵢ collectively form the output bitstream BS.

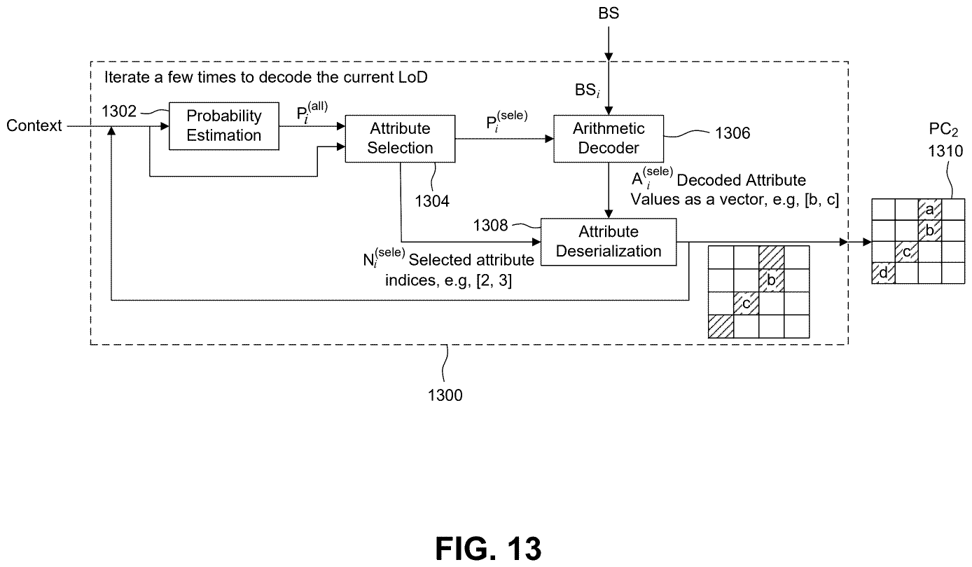

FIG. 13 is a process diagram illustrating an example attribute decoding of the current LoD with an adaptive coding coder according to some embodiments.

FIG. 13 shows the decoder 1300, which iterates a few times to decode the current LoD. Particularly, the decoder 1300 shows the i-th decoding iteration in which some of the voxels have already been decoded in the previous (i−1) encoding iterations.

When performing decoding at the i-th decoding iteration, two inputs are used: (1) the i-th sub-bitstream BSᵢ containing the attribute information to be decoded at the i-th decoding iteration; and (2) the context information for the already-decoded attributes. The probability estimation block 1302 estimates the probability distributions of all the remaining attributes to be decoded, denoted as

$${P}_{i}^{( all )} .$$

The probability distributions

$${P}_{i}^{( all )} .$$

on the decoder side are the same as

$${P}_{i}^{( all )}$$

on the encoder side (FIG. 12).

Based on

$${P}_{i}^{( all )}$$

and the context information, the Attribute Selection block 1304 identifies a few attributes among all the attributes to be decoded in the current iteration. The Attribute Selection block 1304 outputs the indices of the selected attributes, denoted as

$${N}_{i}^{( sele )} .$$

Additionally, the Attribute Selection block 1304 outputs the probability distributions of the selected attributes, denoted by

$${P}_{i}^{( sele )} .$$

The Attribute Selection block 1304 on the decoder (FIG. 13) is identical to the one on the encoder (FIG. 12).

Given the sub-bitstream BSᵢ and the associated probability distributions

$${P}_{i}^{( sele )} ,$$

the arithmetic decoder 1306 decodes BSᵢ and outputs the decoded selected attribute values

$${A}_{i}^{( sele )} .$$

The Attribute Deserialization block 1308 takes as inputs the decoded selected attribute values

$${A}_{i}^{( sele )} ,$$

and the selected attribute indices

$${N}_{i}^{( sele )} .$$

The Attribute Deserialization block 1308 outputs the attribute values in the vector

$${A}_{i}^{( sele )}$$

back to the 3D voxels associated with the indices specified by

$${N}_{i}^{( sele )}$$

for point cloud PC₂ (1310). The above decoding iteration repeats until all the attributes in the current LoD have been decoded.

### Geometry Coding

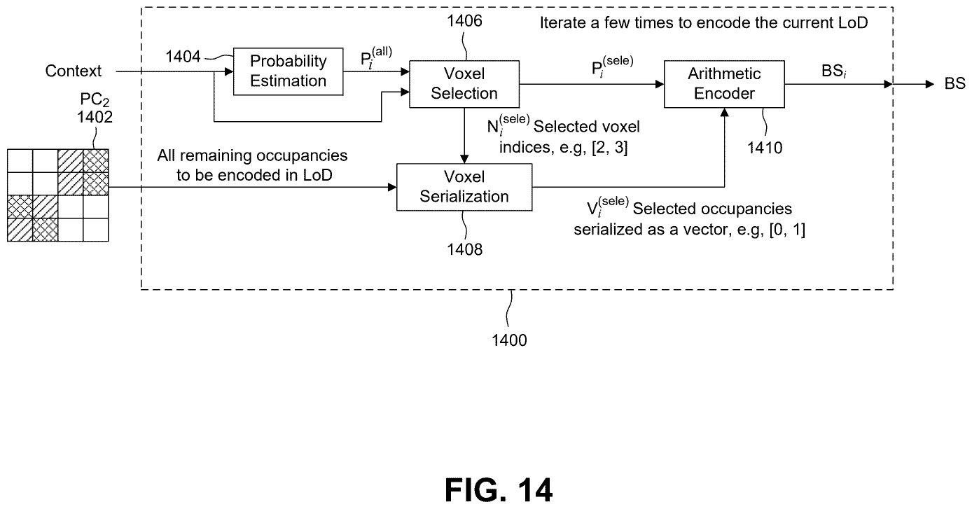

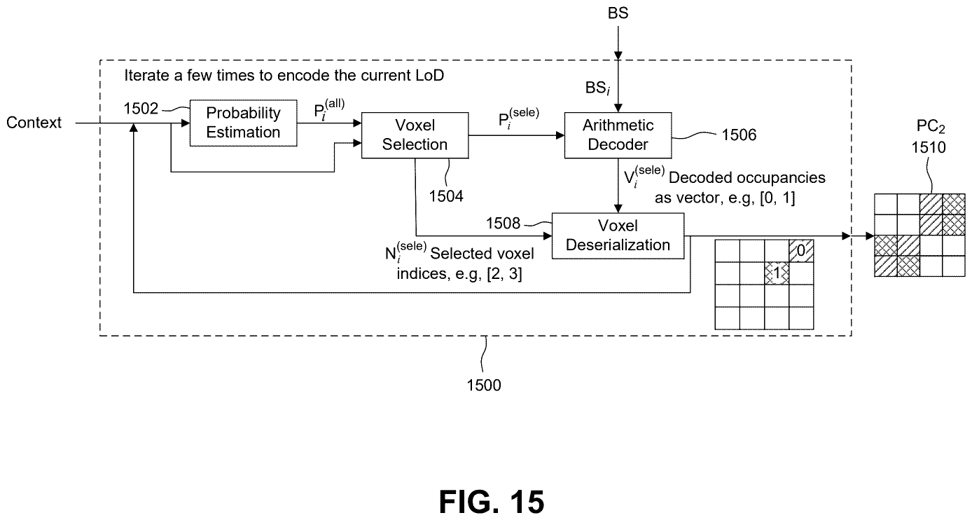

FIG. 14 is a process diagram illustrating an example geometry encoding of the current LoD with an adaptive coding coder according to some embodiments. For some embodiments, the content-adaptive coding order determination is also applicable for point cloud geometry coding. FIGS. 14 and 15 show example encoding and decoding diagrams, respectively. The overall encoding and decoding processes are similar to attribute coding processes.

When performing encoding at the i-th encoding iteration, two inputs are used: (1) all of the remaining occupancies to be encoded for point cloud PC₂ (1402); and (2) the context information for the already-encoded occupancies. The probability estimation block 1404 estimates the probability distributions of all the remaining occupancies to be encoded, denoted as

$${P}_{i}^{( all )} .$$

The geometry encoding process 1400 of the i-th iteration (FIG. 14) is similar to that of the attribute encoding process shown in FIG. 12. However, instead of using an Attribute Selection block to pick the attribute values to be encoded, a Voxel Selection block 1406 is applied to pick the voxels to be encoded in the i-th iteration. The Voxel Selection block 1406 outputs the indices of the selected attributes, denoted as

$${N}_{i}^{( sele )} .$$

Additionally, the Voxel Selection block 1406 outputs the probability distributions of the selected voxels, denoted by

$${P}_{i}^{( sele )} .$$

The selected probability distributions

$${P}_{i}^{( sele )}$$

come from the probability distributions of all the remaining attributes to be encoded

$${P}_{i}^{( all )} .$$

In other words,

$${P}_{i}^{( sele )} ∈ {P}_{i}^{( all )} .$$

In some embodiments, the Voxel Selection block 1406 is a neural-network-based block or a non-learning-based block, which performs a binary classification of all of the remaining attributes to be coded in this LoD, and classifies them as either selected or not selected.

Additionally, instead of the Attribute Serialization process, a Voxel Serialization process 1408 is applied to arrange the selected voxels into a vector denoted by

$${V}_{i}^{( sele )} .$$

The vector

$${V}_{i}^{( sele )}$$

contains all the binary voxel occupancy status to be encoded in this i-th iteration.

The Arithmetic Encoder 1410 encodes the occupancy status

$${V}_{i}^{( sele )}$$

according to the associated occupancy probability distributions

$${P}_{i}^{( sele )} ,$$

leading to the bitstream BSᵢ. The encoding iteration repeats until all the attributes in the current LoD have been encoded.

FIG. 15 is a process diagram illustrating an example geometry decoding of the current LoD with an adaptive coding coder according to some embodiments. The geometry decoding process of the i-th iteration (FIG. 15) is similar to that of the attribute decoding process shown in FIG. 12.

When performing decoding at the i-th decoding iteration, two inputs are used: (1) the i-th sub-bitstream BSᵢ containing the occupancy information to be decoded at the i-th decoding iteration; and (2) the context information for the already-decoded occupancies. The probability estimation block 1502 estimates the probability distributions of all the remaining occupancies to be decoded, denoted as

$${P}_{i}^{( all )} .$$

The probability distributions

$${P}_{i}^{( all )}$$

on the decoder side are the same as

$${P}_{i}^{( all )}$$

on the encoder side (FIG. 14)

Instead of using the Attribute Selection block to pick the attribute values to be decoded, a Voxel Selection block 1504 is applied to pick the voxels to be decoded in the i-th iteration. The Voxel Selection block 1504 on the decoder (FIG. 15) is identical to the one on the encoder (FIG. 14).

The Arithmetic Decoder 1506 decodes the occupancy status

$${V}_{i}^{( sele )}$$

using the inputs of the associated occupancy probability distributions

$${P}_{i}^{( sele )}$$

and the bitstream BSᵢ.

Additionally, instead of the Attribute Deserialization process, a Voxel Deserialization process 1508 is applied to label the selected voxels according to the decoded voxel occupancies

$${V}_{i}^{( sele )} .$$

The decoding iteration repeats until all the voxel occupancies in the current LoD have been decoded.

### Learning-Based Selection Block

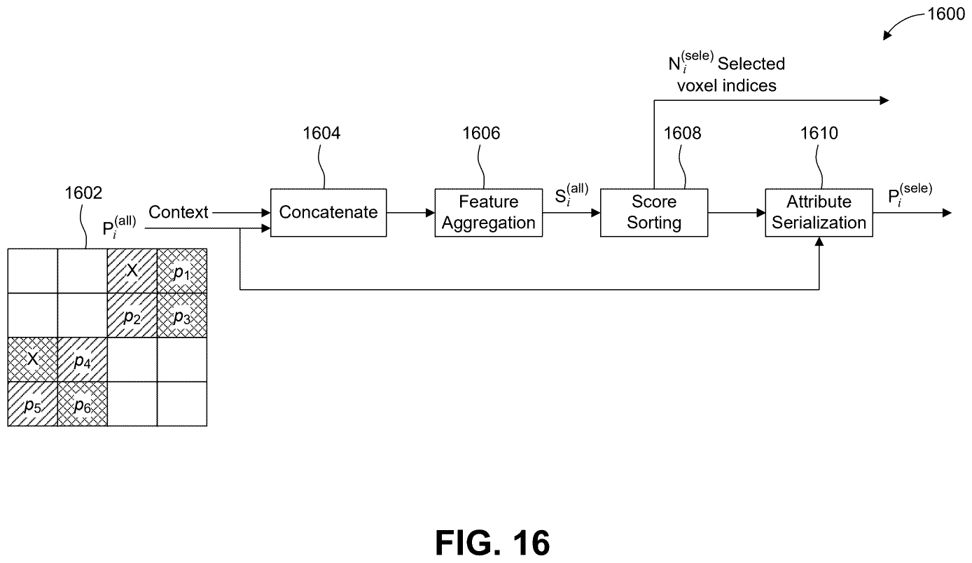

FIG. 16 is a process diagram illustrating an example learning-based voxel selection process according to some embodiments. FIG. 16 provides more detailed information about the design of the Attribute Selection block and the Voxel Selection block for some embodiments. Particularly, for some embodiments, the selection blocks are based on neural networks, as shown in FIG. 16. Attribute Selection in the case of attribute coding is used as an example, The same rationale applies to Voxel Selection for geometry coding.

The probability distributions of all remaining attributes to be coded

$$( {P}_{i}^{( all )} )$$

1602 are concatenated with the context feature in the Concatenation block 1604.

The concatenated feature is inputted to the Feature Aggregation block 1606. The Feature Aggregation block 1606 refines the concatenated feature and outputs a score (a scalar value) for each remaining attribute to be coded. This score evaluates to the worthiness of encoding/decoding an attribute value in a current coding iteration in terms of overall compression performance. For instance, for some attribute values that are difficult to encode/decode, they may be associated with a higher score indicating that these values should be coded first to lay a good foundation for the coding of the rest of the attributes. In some embodiments, the Feature Aggregation block 1606 is constructed based on 3D sparse convolutional layers. In some embodiments, the Feature Aggregation block 1606 is based on ResNet blocks. In some embodiments, the Feature Aggregation block 1606 is based on Transformer blocks. The output scores for each remaining attribute to be coded constitute a vector

$${S}_{i}^{( all )}$$

and an output of the Feature Aggregation block 1606.

The Score Sorting block 1608 sorts all the scores in descending order. The sorting is performed for each 2×2×2 cube, in which the voxels in a cube share the same parent. In the 2D example shown in FIG. 16, the cube becomes a 2D square of size 2×2, highlighted by the shaded squares in

$$( {P}_{i}^{( all )} )$$

1602. For each 2×2×2 cube, the attribute with the highest score in the cube is picked for encoding/decoding in the current coding iteration. The indices of all selected attributes constitute a vector

$${N}_{i}^{( sele )} .$$

The Score Sorting block 1608 outputs the vector

$${N}_{i}^{( sele )} .$$

The rationale for this design is that a neural network is used to characterize the importance of all attribute values to be coded, so that the most impactful attribute values (to the overall coding performance) will be selected for the coding of the current coding iteration.

The indices of the selected attributes

$${N}_{i}^{( sele )}$$

and all the probabilities of the remaining attributes are provided to the Attribute Serialization block 1610. The Attribute Serialization block 1610 takes out the probability values associated with the indices of the selected attributes

$${N}_{i}^{( sele )} .$$

These probability values together form the vector

$${P}_{i}^{( sele )} ,$$

which is the probability distributions of the selected attributes.

The learning-based selection process 1600 outputs

$${N}_{i}^{( sele )} and {P}_{i}^{( sele )}$$

for the subsequent steps.

### Non-Learning-Based Voxel Selection

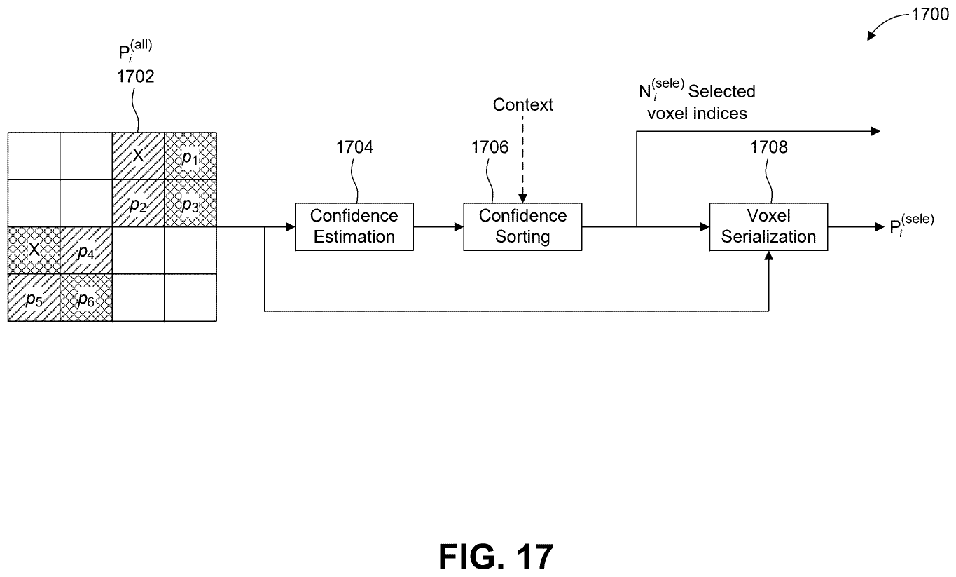

FIG. 17 is a process diagram illustrating an example non-learning-based voxel selection process according to some embodiments. In some embodiments, the voxel selection block for geometry coding may be a non-learning-based block. A non-learning-based deterministic block is applied to determine directly which voxel is to be coded in the new coding iteration. An example non-learning-based voxel selection block 1700 is shown in FIG. 17. A dotted arrow is used in FIG. 17 to indicate that this non-learning-based voxel selection block 1700 does not use context information as an input.

Given all the estimated occupancy probabilities of the remaining voxels to be coded, the Confidence Estimation block 1704 estimates the confidence of the estimated occupancy probabilities. Particularly, for each provided occupancy probability value p, the Confidence Estimation block 1704 estimates its confidence by computing Eq. 1:

$$c = 2 \cdot \vert p - 0.5 \vert \qquad ( 1 )$$

The value c, which ranges from 0 to 1, indicates a confidence of the occupancy probability. The Confidence Estimation block 1704 outputs all the confidence values of the remaining voxels to be coded.

The Confidence Sorting block 1706 sorts all the confidence values in ascending order. The sorting is performed for each 2×2×2 cube, in which the voxels in a cube share the same parent. In the 2D example shown in FIG. 17, the cube becomes a 2D square of size 2×2, which are shown as shaded squares for

$${P}_{i}^{( all )}$$

1702. For each 2×2×2 cube, the voxel in the cube with the smallest confidence is picked for encoding/decoding in the current coding iteration. The Confidence Sorting block 1706 outputs the indices of all selected voxels, which constitute a vector

$${N}_{i}^{( sele )} .$$

The rationale for this design is that encoding/decoding starts with the most difficult voxels so that a solid foundation is laid at the beginning for the encoding/decoding of the remaining voxels.

The indices of the selected voxels

$${N}_{i}^{( sele )}$$

and all the probabilities of the remaining voxels are provided to the Voxel Serialization block 1708. The Voxel Serialization block 1708 takes out the probability values associated with the indices of the selected voxels

$${N}_{i}^{( sele )} .$$

These probability values together form the vector

$${P}_{i}^{( sele )} ,$$

which are the probability distributions of the selected voxels.

The non-learning-based voxel selection process 1700 outputs

$${N}_{i}^{( sele )} and {P}_{i}^{( sele )}$$

for the subsequent steps.

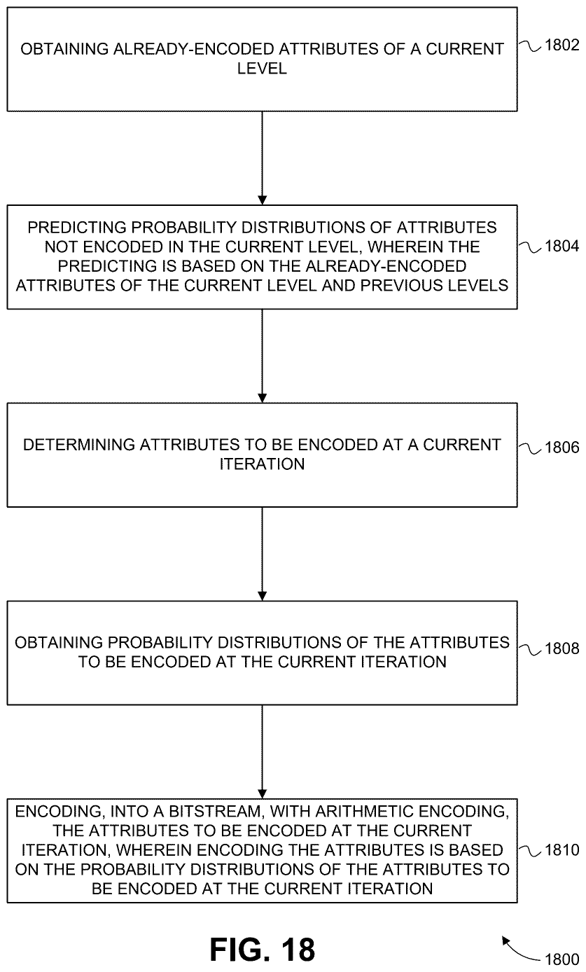

FIG. 18 is a flowchart illustrating an example process for iteratively encoding point cloud data at an octree level according to some embodiments. For some embodiments, an example process 1800 may include obtaining 1802 already-encoded attributes of a current level. For some embodiments, the example process 1800 may further include predicting 1804 probability distributions of attributes not encoded in the current level, wherein the predicting is based on the already-encoded attributes of the current level and previous levels. For some embodiments, the example process 1800 may further include determining 1806 attributes to be encoded at a current iteration. For some embodiments, the example process 1800 may further include obtaining 1808 probability distributions of the attributes to be encoded at the current iteration. For some embodiments, the example process 1800 may further include encoding 1810, into a bitstream, with arithmetic encoding, the attributes to be encoded at the current iteration, wherein encoding the attributes is based on the probability distributions of the attributes to be encoded at the current iteration.

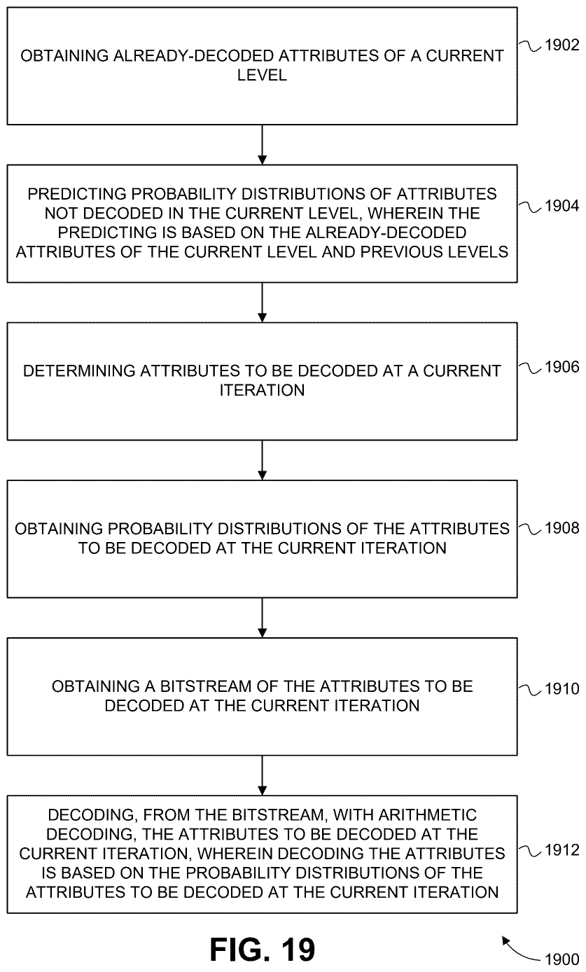

FIG. 19 is a flowchart illustrating an example process for iteratively decoding point cloud data at an octree level according to some embodiments. For some embodiments, an example process 1900 may include obtaining 1902 already-decoded attributes of a current level. For some embodiments, the example process 1900 may further include predicting 1904 probability distributions of attributes not decoded in the current level, wherein the predicting is based on the already-decoded attributes of the current level and previous levels. For some embodiments, the example process 1900 may further include determining 1906 attributes to be decoded at a current iteration. For some embodiments, the example process 1900 may further include obtaining 1910 probability distributions of the attributes to be decoded at the current iteration. For some embodiments, the example process 1900 may further include obtaining 1912 a bitstream of the attributes to be decoded at the current iteration. For some embodiments, the example process 1900 may further include decoding 1914, from the bitstream, with arithmetic decoding, the attributes to be decoded at the current iteration, wherein decoding the attributes is based on the probability distributions of the attributes to be decoded at the current iteration.

An example apparatus in accordance with some embodiments may include at least one processor configured to perform any one of the methods described within this application. An example apparatus in accordance with some embodiments may include a computer-readable medium storing instructions for causing one or more processors to perform any one of the methods described within this application. An example apparatus in accordance with some embodiments may include at least one processor and at least one non-transitory computer-readable medium storing instructions for causing the at least one processor to perform any one of the methods described within this application. An example signal in accordance with some embodiments may include a bitstream generated according to any one of the methods described within this application.

While the methods and systems in accordance with some embodiments are generally discussed in context of extended reality (XR), some embodiments may be applied to any XR contexts such as, e.g., virtual reality (VR)/mixed reality (MR)/augmented reality (AR) contexts. Also, although the term “head mounted display (HMD)” is used herein in accordance with some embodiments, some embodiments may be applied to a wearable device (which may or may not be attached to the head) capable of, e.g., XR, VR, AR, and/or MR for some embodiments.

A first example method in accordance with some embodiments may include: obtaining already-decoded attributes of a current level; predicting probability distributions of attributes not decoded in the current level, wherein the predicting is based on the already-decoded attributes of the current level and previous levels; determining attributes to be decoded at a current iteration; obtaining probability distributions of the attributes to be decoded at the current iteration; obtaining a bitstream of the attributes to be decoded at the current iteration; and decoding, from the bitstream, with arithmetic decoding, the attributes to be decoded at the current iteration, wherein decoding the attributes is based on the probability distributions of the attributes to be decoded at the current iteration.

For some embodiments of the first example method, wherein determining attributes to be decoded at the current iteration includes performing attribute selection to select the attributes to be decoded at the current iteration, and wherein performing attribute selection is based on the probability distributions of the attributes to be decoded at the current iteration.

Some embodiments of the first example method may further include performing attribute deserialization using the attributes selected to be decoded.

For some embodiments of the first example method, performing attribute deserialization includes outputting a feedback loop of the attributes to be decoded at the current iteration.

For some embodiments of the first example method, attribute selection includes: concatenating the attributes remaining to be encoded; performing feature aggregation on the concatenated attributes remaining to be decoded, wherein the feature aggregation generates a score for each of the attributes remaining to be decoded; and sorting the scores into an order for decoding the attributes, wherein decoding the attributes is further based on the order for decoding the attributes.

For some embodiments of the first example method, attribute selection includes: generating a confidence level for each of the attributes remaining to be decoded; and sorting the confidence levels into an order for decoding the attributes, wherein decoding the attributes is further based on the order for decoding the attributes.

For some embodiments of the first example method, the attributes include voxel occupancies.

For some embodiments of the first example method, wherein determining attributes to be decoded at the current iteration includes performing voxel selection to select voxel occupancies to be decoded at the current iteration, and wherein performing voxel selection is based on the probability distributions of the attributes to be decoded at the current iteration.

Some embodiments of the first example method may further include performing voxel deserialization using the voxel occupancies selected to be decoded.

A first example apparatus in accordance with some embodiments may include: a processor; and a memory storing instructions operative, when executed by the processor, to cause the apparatus to: obtain already-decoded attributes of a current level; predict probability distributions of attributes not decoded in the current level, wherein the predicting is based on the already-decoded attributes of the current level and previous levels; determine attributes to be decoded at a current iteration; obtain probability distributions of the attributes to be decoded at the current iteration; obtain a bitstream of the attributes to be decoded at the current iteration; and decode, from the bitstream, with arithmetic decoding, the attributes to be decoded at the current iteration, wherein decoding the attributes is based on the probability distributions of the attributes to be decoded at the current iteration.

A second example method in accordance with some embodiments may include: obtaining already-encoded attributes of a current level; predicting probability distributions of attributes not encoded in the current level, wherein the predicting is based on the already-encoded attributes of the current level and previous levels; determining attributes to be encoded at a current iteration; obtaining probability distributions of the attributes to be encoded at the current iteration; and encoding, into a bitstream, with arithmetic encoding, the attributes to be encoded at the current iteration, wherein encoding the attributes is based on the probability distributions of the attributes to be encoded at the current iteration.

For some embodiments of the second example method, determining attributes to be encoded at the current iteration includes: performing attribute selection to select the attributes to be encoded; and performing attribute serialization using the attributes remaining to be encoded.

For some embodiments of the second example method, performing attribute selection is based on the probability distributions of the attributes to be encoded at the current iteration.

For some embodiments of the second example method, performing attribute serialization generates a vector of attributes selected to be encoded at the current iteration.

For some embodiments of the second example method, attribute selection includes: concatenating the attributes remaining to be encoded; performing feature aggregation on the concatenated attributes remaining to be encoded, wherein the feature aggregation generates a score for each of the attributes remaining to be encoded; and sorting the scores into an order for encoding the attributes, wherein encoding the attributes is further based on the order for encoding the attributes.

For some embodiments of the second example method, attribute selection includes: generating a confidence level for each of the attributes remaining to be encoded; and sorting the confidence levels into an order for encoding the attributes, wherein encoding the attributes is further based on the order for encoding the attributes.

For some embodiments of the second example method, the attributes include voxel occupancies.

For some embodiments of the second example method, determining attributes to be encoded at the current iteration includes: performing voxel selection to select voxel occupancies to be encoded; and performing voxel serialization using voxel occupancies remaining to be encoded.

For some embodiments of the second example method, performing voxel selection is based on probability distributions of the voxel occupancies to be encoded at the current iteration.

For some embodiments of the second example method, performing voxel serialization generates a vector of the voxel occupancies selected to be encoded at the current iteration.

One or more embodiments provide a computer program including instructions which when executed by one or more processors cause such processors to perform the encoding and/or decoding methods according to any of the embodiments described above. One or more embodiments also provide a computer readable storage medium having stored thereon instructions for encoding or decoding video data according to the methods described above.

One or more embodiments provide a computer readable storage medium having stored thereon video data generated according to the methods described above. One or more embodiments also provide a method and apparatus for transmitting or receiving video data generated according to the methods described above.

The embodiments described herein may be implemented in, for example, a method or a process, an apparatus, a software program, a data stream, or a signal. Even if only discussed in the context of a single form of implementation (e.g., as a method), the implementation of such features may also be implemented in other forms. An apparatus may be implemented in, for example, appropriate hardware, software, and firmware. Corresponding methods may be implemented in, for example, a processor.

Various numeric values are used in the present application. Such specific values are for example purposes and the embodiments described are not limited to these specific values.

Various methods are described herein, and such methods include one or more steps or actions for achieving the described method. Unless a specific order of steps or actions is required for the proper operation of the method, the order and/or use of specific steps and/or actions may be modified or combined. Additionally, terms such as “first”, “second”, etc. may be used in various embodiments to modify an element, component, step, operation, etc., for example, a “first decoding” and a “second decoding”. Use of such terms does not imply an order to the operations unless specifically required.

The present application may refer to “determining” various pieces of information. Determining information may include one or more of, for example, estimating, calculating, predicting, or retrieving (e.g., from memory) the information.

The present application may refer to “accessing” various pieces of information. Accessing information may include one or more of, for example, receiving, retrieving (e.g., from memory), storing, moving, copying, calculating, determining, predicting, or estimating the information. Similarly, the present application may refer to “receiving” various pieces of information. Receiving information may include one or more of, for example, accessing or retrieving (e.g., from memory) the information.

It is to be understood that use of any of the following “/”, “and/or”, and “at least one of” is intended to encompass all possible selections of listed items, taken either individually or in any combination thereof.

While specific embodiments have been described in the foregoing description in connection with the accompanying drawings, it should be understood that embodiments described herein are examples only and should not be taken as limiting the scope of the present application or the following claims. Although features and elements are described herein in particular combinations, those of ordinary skill in the art will appreciate that such features or elements may be used alone or in any combination with the other features and elements. It is understood, therefore, that the overall teachings of the present application are not limited to the particular embodiments, implementations, and examples disclosed herein, but are intended to cover variations, modifications, and alternatives as defined by the appended claims and any and all equivalents thereof.

This application describes a variety of aspects, including tools, features, embodiments, models, approaches, etc. Many of these aspects are described with specificity and, at least to show the individual characteristics, are often described in a manner that may sound limiting. However, this is for purposes of clarity in description, and does not limit the application or scope of those aspects. Indeed, all of the different aspects can be combined and interchanged to provide further aspects. Moreover, the aspects can be combined and interchanged with aspects described in earlier filings as well.

Various numeric values may be used in the present application, for example. The specific values are for example purposes and the aspects described are not limited to these specific values.

Embodiments described herein may be carried out by computer software implemented by a processor or other hardware, or by a combination of hardware and software. As a non-limiting example, the embodiments can be implemented by one or more integrated circuits. The processor can be of any type appropriate to the technical environment and can encompass one or more of microprocessors, general purpose computers, special purpose computers, and processors based on a multi-core architecture, as non-limiting examples.

When a figure is presented as a flow diagram, it should be understood that it also provides a block diagram of a corresponding apparatus. Similarly, when a figure is presented as a block diagram, it should be understood that it also provides a flow diagram of a corresponding method/process.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information can include one or more of, for example, estimating the information, calculating the information, predicting the information, or retrieving the information from memory.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items as are listed.

Implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

Note that various hardware elements of one or more of the described embodiments are referred to as “modules” that carry out (i.e., perform, execute, and the like) various functions that are described herein in connection with the respective modules. As used herein, a module includes hardware (e.g., one or more processors, one or more microprocessors, one or more microcontrollers, one or more microchips, one or more application-specific integrated circuits (ASICs), one or more field programmable gate arrays (FPGAs), one or more memory devices) deemed suitable by those of skill in the relevant art for a given implementation. Each described module may also include instructions executable for carrying out the one or more functions described as being carried out by the respective module, and it is noted that those instructions could take the form of or include hardware (i.e., hardwired) instructions, firmware instructions, software instructions, and/or the like, and may be stored in any suitable non-transitory computer-readable medium or media, such as commonly referred to as RAM, ROM, etc.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method of iteratively decoding point cloud data at an octree level, comprising:
obtaining already-decoded attributes of a current level;
predicting probability distributions of attributes not decoded in the current level,
wherein the predicting is based on the already-decoded attributes of the current level and previous levels;
determining attributes to be decoded at a current iteration;
obtaining probability distributions of the attributes to be decoded at the current iteration;
obtaining a bitstream of the attributes to be decoded at the current iteration; and
decoding, from the bitstream, with arithmetic decoding, the attributes to be decoded at the current iteration,
wherein decoding the attributes is based on the probability distributions of the attributes to be decoded at the current iteration.

2. The method of claim 1,
wherein determining attributes to be decoded at the current iteration comprises performing attribute selection to select the attributes to be decoded at the current iteration, and
wherein performing attribute selection is based on the probability distributions of the attributes to be decoded at the current iteration.

3. The method of claim 2, further comprising performing attribute deserialization using the attributes selected to be decoded.

4. The method of claim 3, wherein performing attribute deserialization comprises outputting a feedback loop of the attributes to be decoded at the current iteration.

5. The method of claim 2, wherein attribute selection comprises:
concatenating the attributes remaining to be encoded;
performing feature aggregation on the concatenated attributes remaining to be decoded,
wherein the feature aggregation generates a score for each of the attributes remaining to be decoded; and
sorting the scores into an order for decoding the attributes,
wherein decoding the attributes is further based on the order for decoding the attributes.

6. The method of claim 2, wherein attribute selection comprises:
generating a confidence level for each of the attributes remaining to be decoded; and
sorting the confidence levels into an order for decoding the attributes,
wherein decoding the attributes is further based on the order for decoding the attributes.

7. The method of claim 1, wherein the attributes comprise voxel occupancies.

8. The method of claim 7,
wherein determining attributes to be decoded at the current iteration comprises performing voxel selection to select voxel occupancies to be decoded at the current iteration, and
wherein performing voxel selection is based on the probability distributions of the attributes to be decoded at the current iteration.

9. The method of claim 8, further comprising performing voxel deserialization using the voxel occupancies selected to be decoded.

10. An apparatus comprising:
a processor; and
a memory storing instructions operative, when executed by the processor, to cause the apparatus to:
obtain already-decoded attributes of a current level;
predict probability distributions of attributes not decoded in the current level,
wherein the predicting is based on the already-decoded attributes of the current level and previous levels;
determine attributes to be decoded at a current iteration;
obtain probability distributions of the attributes to be decoded at the current iteration;
obtain a bitstream of the attributes to be decoded at the current iteration; and
decode, from the bitstream, with arithmetic decoding, the attributes to be decoded at the current iteration,
wherein decoding the attributes is based on the probability distributions of the attributes to be decoded at the current iteration.

11. A method of iteratively encoding point cloud data at an octree level, comprising:
obtaining already-encoded attributes of a current level;
predicting probability distributions of attributes not encoded in the current level,
wherein the predicting is based on the already-encoded attributes of the current level and previous levels;
determining attributes to be encoded at a current iteration;
obtaining probability distributions of the attributes to be encoded at the current iteration; and
encoding, into a bitstream, with arithmetic encoding, the attributes to be encoded at the current iteration,
wherein encoding the attributes is based on the probability distributions of the attributes to be encoded at the current iteration.

12. The method of claim 11, wherein determining attributes to be encoded at the current iteration comprises:
performing attribute selection to select the attributes to be encoded; and
performing attribute serialization using the attributes remaining to be encoded.

13. The method of claim 12, wherein performing attribute selection is based on the probability distributions of the attributes to be encoded at the current iteration.

14. The method of claim 12, wherein performing attribute serialization generates a vector of attributes selected to be encoded at the current iteration.

15. The method of claim 12, wherein attribute selection comprises:
concatenating the attributes remaining to be encoded;
performing feature aggregation on the concatenated attributes remaining to be encoded,
wherein the feature aggregation generates a score for each of the attributes remaining to be encoded; and
sorting the scores into an order for encoding the attributes,
wherein encoding the attributes is further based on the order for encoding the attributes.

16. The method of claim 12, wherein attribute selection comprises:
generating a confidence level for each of the attributes remaining to be encoded; and
sorting the confidence levels into an order for encoding the attributes,
wherein encoding the attributes is further based on the order for encoding the attributes.

17. The method of claim 11, wherein the attributes comprise voxel occupancies.

18. The method of claim 17, wherein determining attributes to be encoded at the current iteration comprises:
performing voxel selection to select voxel occupancies to be encoded; and
performing voxel serialization using voxel occupancies remaining to be encoded.

19. The method of claim 17, wherein performing voxel selection is based on probability distributions of the voxel occupancies to be encoded at the current iteration.

20. The method of claim 17, wherein performing voxel serialization generates a vector of the voxel occupancies selected to be encoded at the current iteration.
